(19) United States
(12) Patent Application Publication
(10) Pub. No.: US 2008/0289192 A1
(43) Pub. Date: Nov. 27, 2008

(54) Biased comb attachment

(76) Inventor: Gino Martelli, Amherst, NY (US)

Correspondence Address: SIMPSON & SIMPSON, PLLC, 5555 MAIN STREET, WILLIAMSVILLE, NY, 14221-5406, US

(21) Appl. No.: 11/805,387

(22) Filed: May 22, 2007

(51) Int. Cl. B26B 19/00; A45D 7/00

(52) U.S. Cl. 30/233.5; 132/200

(57) ABSTRACT

Biased or contoured comb attachments for hair clippers having a plurality of spaced apart parallel teeth extending substantially perpendicularly from a base of the comb attachment, wherein the plurality of teeth have at least a first tooth and a second tooth. The first tooth has a first contoured shape and said second tooth has a second contoured shape, wherein the first and second contoured shapes are different. The comb attachment preferably includes at least a third tooth having a third contoured shape, wherein the third contoured shape is different than the first and second contoured shapes. Together, a biased curved top surface is formed by the first, second and third contoured shapes.

### FIELD OF THE INVENTION

The invention relates to comb attachments for hair cutting devices such as hair clippers, especially electric hair clippers.

### BACKGROUND OF THE INVENTION

Comb attachments for electric hair clippers are known in the art. Several comb attachments are available for use with hair cutting devices such as electric hair clippers. Generally, the comb attachments are removably secured to a cutting end of the hair cutting device, proximate reciprocating cutting blades. The comb attachment comb is commonly used to keep the cutting blades of the hair cutting device a constant distance from the surface where the hair is being cut. The comb attachments facilitate the cutting of hair to a uniform length across surfaces of varying contours, e.g., a person's head.

U.S. Design Pat. No. D175,141 (Andis) illustrates a commonly used comb attachment. The comb has a tapered front end that allows for the comb to glide easily through the hair, separating the hair and aligning the hair to be cut. As previously discussed, the comb attachments described by Andis are limited to cutting hair a constant length. The length is determined by the length and depth of the comb attachment. In order to vary the length of hair for a hair style, like in the case of creating a biased or tapered hair cut where the length of hair increases from bottom to top of the hair style, the hair clippers would have to be held at an angle relative the surface or trim the hair manually.

Although commonly performed, holding the clipper at an angle relative the surface leads to inaccuracies in symmetry across, for example, the left and right sides of a person's head of hair. Specifically, it is very difficult to trim, with electric clippers held at an angle, a right side of a person's head then replicate that angle specifically for that person's left side. Additionally, resorting to manual correction of the inaccuracies with a pair of scissors greatly increases the time required to cut a person's hair.

Thus, what is needed then is a comb attachment that allows for a more efficient cutting of hair for a biased or tapered hair style that overcomes the deficiencies of the prior art.

### BRIEF SUMMARY OF THE INVENTION

The present invention broadly comprises comb attachments for hair clippers having a plurality of spaced apart parallel teeth extending substantially perpendicularly from a base of the comb attachment, wherein the plurality of teeth have at least a first tooth and a second tooth. The first tooth has a first contoured shape and said second tooth has a second contoured shape, wherein the first and second contoured shapes are different. The comb attachment further includes an attachment means for removably securing the comb attachment to the hair clipper.

Preferably, the comb attachment further includes at least a third tooth having a third contoured shape, wherein the third contoured shape is different than the first and second contoured shapes. Together, a biased curved top surface is formed by the first, second and third contoured shapes. Also preferable is that a cross-section of the biased curved top surface is substantially parabolic in shape.

In an alternative embodiment, the first tooth includes a first length and a first depth, and the second tooth includes a second length and a second depth. The second length is longer than the first length and the second depth is larger than the first depth. Preferably, the comb attachment further includes at least a third tooth having a third contoured shape, a third length and a third depth. The third contoured shape is different than the first and second contoured shapes and the third length is longer than the second length and the third depth is larger than the second depth. A biased curved top surface formed by the first, second and third contoured shapes. A cross-section of the biased curved top surface is preferably substantially parabolic in shape.

Most preferably, a packaged set of comb attachments is created, each having unique contoured shapes and unique biased curved top surfaces so that many different surfaces having hair can be accommodated. Specifically, different lengths of hair can be achieved across a broad range of surface shapes, or, e.g., head shapes.

The present invention also broadly comprises comb attachments hair clippers having a plurality of teeth extending in a substantially perpendicularly direction from a base of the comb attachments, each of the plurality of teeth having a curved top edge. A top-face surface is formed by a combination of the curved top edges. The top-face surface has a biased curve in a direction substantially perpendicular to the curved top edges. The comb attachments further include an attachment means for removably securing the comb attachments to the hair clipper.

In most embodiments, the biased curve is substantially parabolic in shape. In other embodiments the biased curve is substantially hyperbolic in shape, has a non-linear slope, or is a non-linear biased curve.

The present invention additionally broadly comprises a method of cutting hair with an electric hair clipper having a biased comb attachment releaseably secured thereto. The method includes the steps of: a) moving the hair clipper in a first direction for at least a portion of a length of the surface, wherein contact is maintained between a top-face surface of the biased comb attachment and the surface and the hair clipper is arranged to cut the hair in a second direction substantially perpendicular to the first direction; b) rotating the biased comb attachment along a first axis; and, c) moving said hair clipper in the first direction for the at least a portion of a length of the surface, wherein contact is maintained between the top-face surface of the biased comb and the surface the said hair clipper is arranged to cut the hair in the second direction. Preferably, the first axis is parallel to the first direction.

In a preferred embodiment the method of cutting hair further includes the steps of: d) moving the hair clipper in a third direction for at least a second portion of a length of the surface, wherein contact is maintained between a top-face surface of the biased comb attachment and the surface and the hair clipper is arranged to cut the hair in a fourth direction substantially perpendicular to the third direction; e) rotating the biased comb attachment relative to the surface; and, f) moving the hair clipper in the third direction for the at least a second portion of a length of the surface, wherein contact is maintained between the top-face surface of the biased comb and the surface and the hair clipper is arranged to cut the hair in the fourth direction.

It is a general object of the present invention to provide a biased comb attachment for efficiently creating a biased or tapered hair style with a standard electric hair clipper.

It is another object of the present invention to provide a plurality of biased comb attachments for creating a multitude of varying biased or tapered hair styles. The plurality of biased comb attachments includes various lengths and contoured comb attachments for the varying hair styles.

It is yet a further object of the present invention to provide a method of cutting hair with a biased comb attachment.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a biased comb attachment attached to an electric hair clipper;

FIG. 2 is a perspective view of a biased comb attachment being attached to an electric hair clipper;

FIG. 3 is a top view of a left-side biased comb attachment;

FIG. 4 is a bottom view of the biased comb attachment shown in FIG. 3;

FIG. 5 is a left side view of the biased comb attachment shown in FIG. 3;

FIG. 6 is a right side view of the biased comb attachment shown in FIG. 3;

FIG. 7 is a front view of the biased comb attachment shown in FIG. 3;

FIG. 8 is a rear view of the biased comb attachment shown in FIG. 3;

FIG. 9 is a cross-sectional view of the biased comb attachment shown in FIG. 3, taken along line 9-9 of FIG. 3;

FIG. 10 is a cross-sectional view of the biased comb attachment shown in FIG. 3, taken along line 10-10 of FIG. 3;

FIG. 11 is a cross-sectional view of the biased comb attachment shown in FIG. 3, taken along line 11-11 of FIG. 3;

FIG. 12 is a bottom view of a right-side biased comb attachment;

FIG. 13 is a bottom view of a shallow left-side biased comb attachment;

FIG. 14 is a front view of the shallow left-side biased comb attachment shown in FIG. 13;

FIG. 15 is a bottom view of a steep left-side biased comb attachment;

FIG. 16 is a front view of the steep left-side biased comb attachment shown in FIG. 15;

FIG. 17 is a front view of a first step of cutting hair with a biased comb attachment attached to an electric hair clipper as shown in FIG. 1;

FIG. 18 is a front view of a second step of cutting hair with a biased comb attachment attached to an electric hair clipper as shown in FIG. 1;

FIG. 19 is a rear perspective view of a third step of cutting hair with a biased comb attachment attached to an electric hair clipper as shown in FIG. 1; and, FIG. 20 is a front view of a tapered or biased haircut created by the apparatus and method according to the invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it should be understood that this invention is not limited to the particular methodology, materials and modifications described and as such may, of course, vary. It should also be understood understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

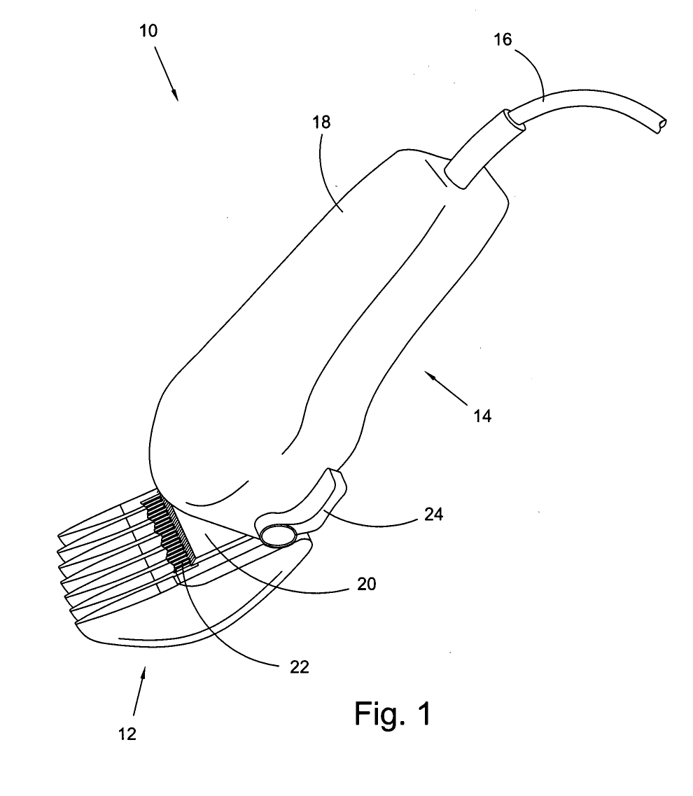

FIG. 1 is a perspective view of hair clipper assembly 10, which includes biased comb attachment 12 attached to electric hair clipper 14. Electric hair clipper 14 includes power cable 16, body 18, lower cutting edge 20 and upper cutting edge 22. In most embodiments, the length of upper cutting edge 22 is adjustable by adjusting lever 24. Otherwise, upper cutting edge 22 remains stationary during use while lower cutting edge 20 reciprocates to create a cutting action to cut hair. The reciprocating motion is usually produced by an electric motor contained within body 18, not shown. It should be appreciated that the invention is in no way limited to the electric clipper shown in the figures, and that any clipper known in the art could be used. The clipper shown in the figures is only a preferred apparatus for use with the invention.

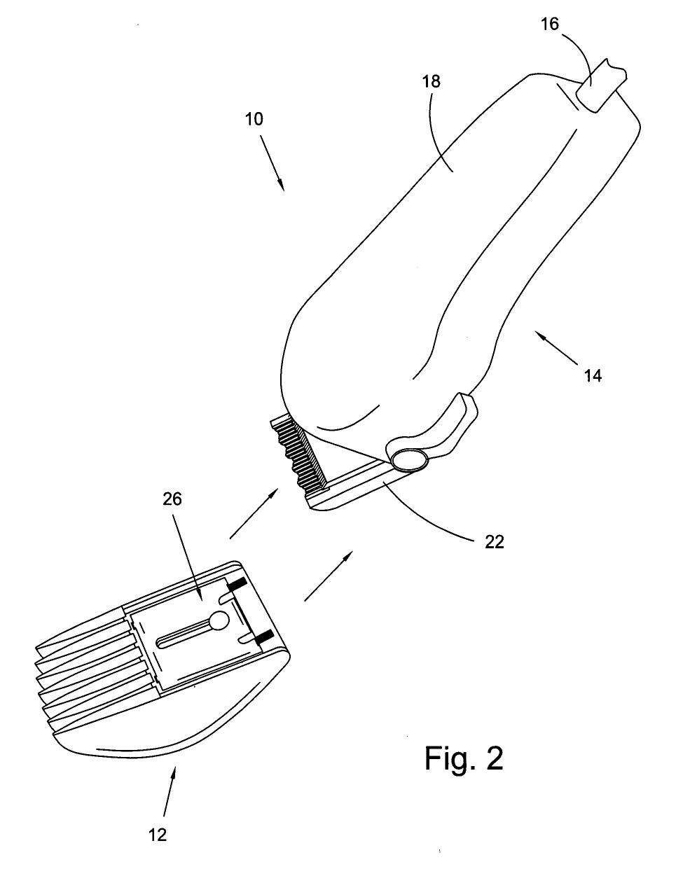

FIG. 2 is a perspective view of biased comb attachment 12 being attached to electric hair clipper 14. Also shown in FIG. 2 is attachment means 26 of comb attachment 12. Attachment means 26 is a spring release clip operatively arranged to removably secure to upper cutting edge 22. It should be appreciated that attachment means 26 does not have to be a spring release clip, but that any type of attachment means known for hair clippers and attachment combs can be used.

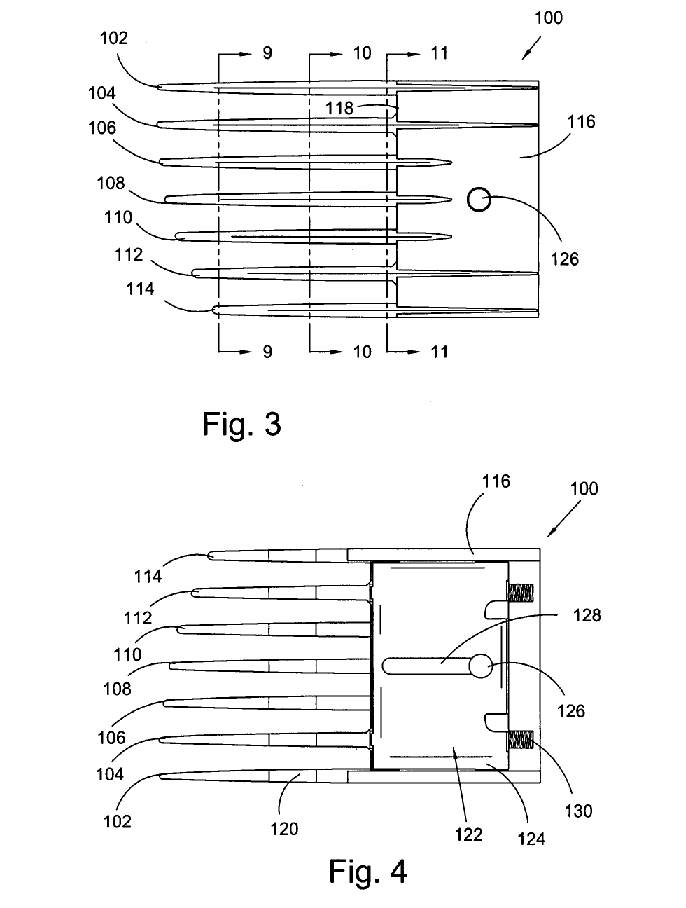

FIG. 3 is a top view of left-side biased comb attachment 100. As will be discussed in more detail below, a left-side biased comb attachment is most preferably suited to cut hair on the head of a person's left side, cutting hair towards the bottom of head shorter than that towards the top. Comb attachment 100 includes teeth or blades 102, 104, 106, 108, 110, 112, and 114. Teeth 102, 104, 106, 108, 110, 112, and 114 extend substantially perpendicularly from base 116 of comb attachment 100. Each tooth 102, 104, 106, 108, 110, 112, and 114 has a respective length extending from edge 118 of base 116 to the left-most tip of each tooth as shown in FIG. 3. Tooth 102 is longer than tooth 104; tooth 104 is longer than tooth 106, and so on.

FIG. 4 is a bottom view of the left-side biased comb attachment 100 shown in FIG. 3. Each tooth 102, 104, 106, 108, 110, 112, and 114 is shown to further include a recessed portion 120, allowing for a flush attachment to an electric hair clipper as shown in FIGS. 1 and 2. Also shown in FIG. 4 is attachment means 122 which in this preferred embodiment includes metal clip 124 slidably secured to base 116 by means of rivet 126 within slot 128 of metal clip 124. Attachment means 122 is operatively arranged to resiliently engage an upper cutting edge of a hair clipper by means of springs 130, as is shown in FIGS. 1-2.

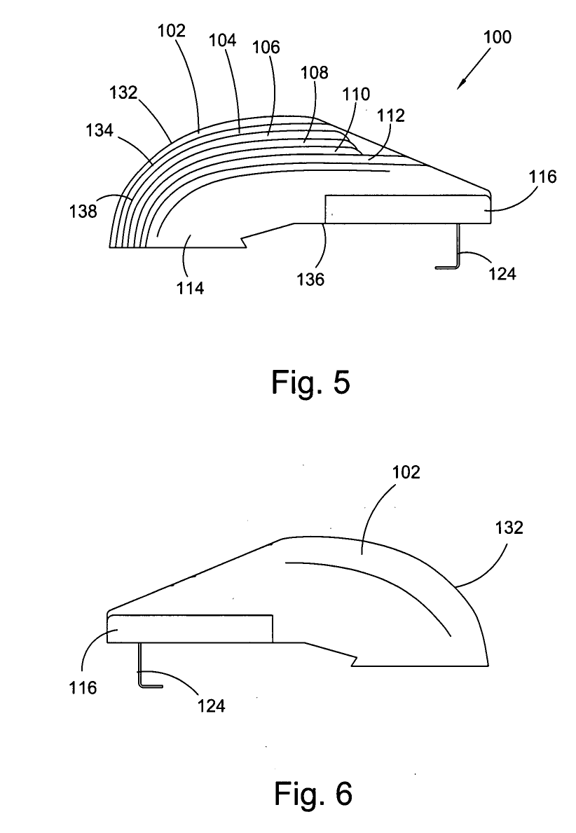

FIG. 5 is a left side view of biased comb attachment 100 shown in FIG. 3. FIG. 5 shows the unique contour of each tooth 102, 104, 106, 108, 110, 112, and 114. Tooth 102 has contour 132 that is unique relative to the contours of each and every other tooth, specifically, e.g., contour 134 of tooth 104. Each tooth 102, 104, 106, 108, 110, 112, and 114 also has a depth measured from edge 136 to the top most edge of each contour of each tooth 102, 104, 106, 108, 110, 112, and 114. The depth of tooth 102 is larger than the depth of tooth 104, the depth of tooth 104 is larger than the depth of tooth 106, and so on. Specifically, e.g., the topmost edge of contour 132 of tooth 102 is higher or further away from edge 136 than the topmost edge of contour 134 of tooth 104. Respectively, the topmost edge of contour 134 of tooth 104 is higher or further away from edge 136 than the topmost edge of contour 138 of tooth 106. FIG. 6 is a left side view of biased comb attachment 100 shown in FIG. 3, showing the largest tooth, tooth 102 having contour 132.

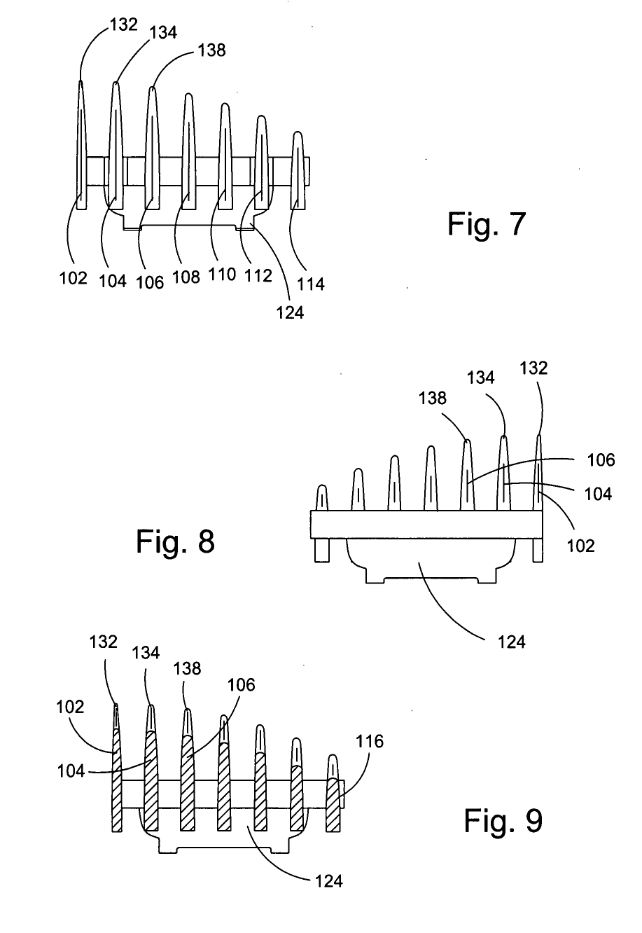

FIGS. 7 and 8 are front and rear views, respectively, of biased comb attachment 100 shown in FIG. 3. Most clearly shown in FIGS. 7 and 8 are the depth relationships described above of contours 132, 134, and 138. That is, the depth of tooth 102 is larger than the depth of tooth 104, and so on.

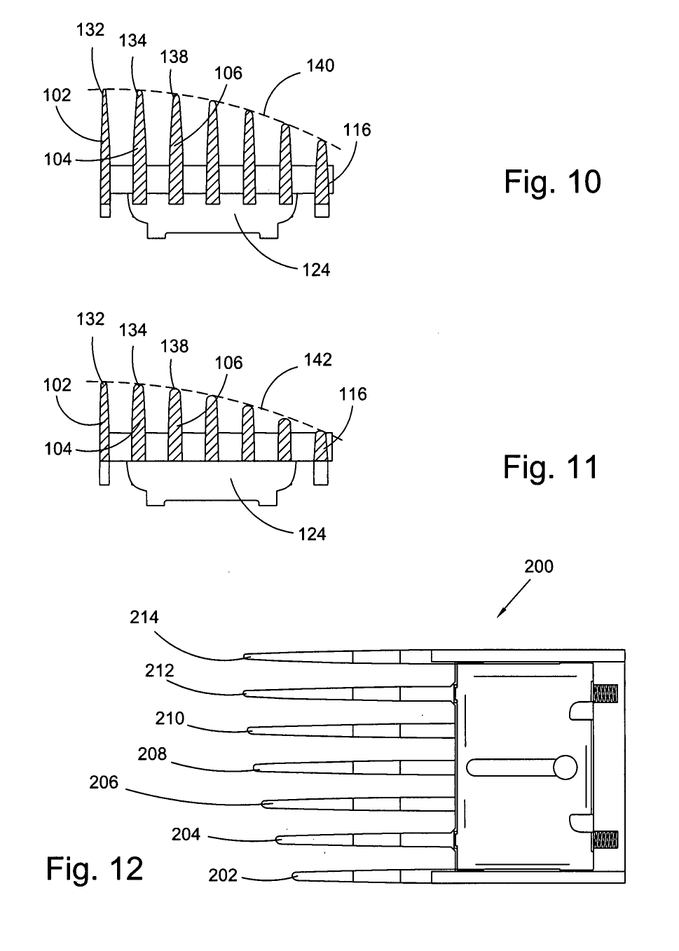

FIGS. 9-11 are cross-sectional views of biased comb attachment 100, taken along lines 9-9, 10-10, and 11-11, respectively, of FIG. 3. FIGS. 9-11 further detail the biased shape of the top surface formed by the unique contours of each tooth 102, 104, 106, 108, 110, 112, and 114. Specifically, the varying heights of contours 132, 134, and 138 of teeth 102, 104, and 106, respectively, should be noted as FIGS. 9-11 are progressive illustrations from the front end of the teeth to the rear end of the teeth in cross section. Specifically, dashed curve 140 of FIG. 10 and dashed curve 142 of FIG. 11 show the contour of the biased top surface of comb attachment 100 across two cross-sections. The curves of dashed curves 140 and 142 are substantially parabolic. In other embodiments, the shapes of curves 140 and 142 may be substantially hyperbolic. Additionally, the curves may have non-linear slopes or be non-linear biased curves. Preferably, a set of biased comb attachments are packaged together in a set, having a biased comb attachment displaying each of these features such that there is a comb attachment for every type of hair style.

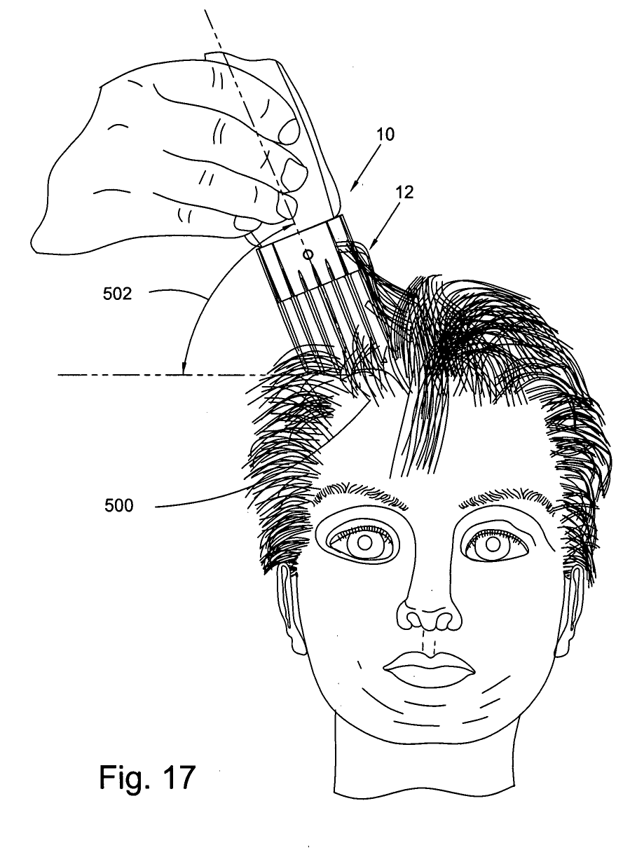

FIG. 12 is a bottom view of right-side biased comb attachment 200. Right-side biased comb attachment 200 is substantially similar to left-side biased comb attachment 100 shown in FIGS. 3-11. However, right-side biased comb attachment 200 is a mirror reflection of comb attachment 100, having a biased shape that is the opposite the biased shape of comb attachment 100. Specifically, the longest and largest tooth 102 of comb attachment 100 is the replaced by the shortest and smallest tooth 202 of comb attachment 200. A similar relationship exists between each tooth 104, 106, 108, 110, 112, and 114 of comb attachment 100 relative to each tooth 204, 206, 208, 210, 212, and 214 of comb attachment 200. In use, right-side biased comb attachment 200 is most suited for a front-to-rear motion in hair cutting along the right side of a person's head, leaving the hair longer on the top than on the bottom to create a tapered or biased hair style. Left-side comb attachment 100 is most suited for a front-to-rear motion in hair cutting along the left side of a person's head. It should be appreciated however, that comb attachment 100 can be used on the right side of a person's head, creating a tapered or biased hair style if instead of a front-to-rear motion a rear-to-front motion is used in cutting hair. These motions are best understood with reference to FIGS. 17-20 discussed in more detail later.

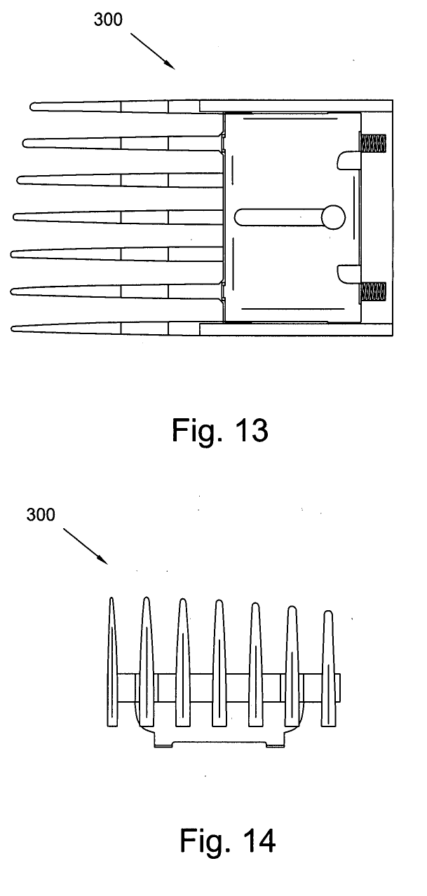

In order to obtain a specific tapered or biased hair style for, it may be necessary to use biased comb attachments of varying dimensions, specifically of varying lengths, depths, and slopes of curvature. FIG. 13 shows left-side biased comb attachment 300 from the bottom. Comb attachment 300 is much shallower in biasing than comb attachment 100 as shown in FIG. 4. FIG. 14 is a front view of comb attachment 300. Comb attachment 300, in use, gives a lesser amount of biasing or tapering to the hair relative to comb attachment 100.

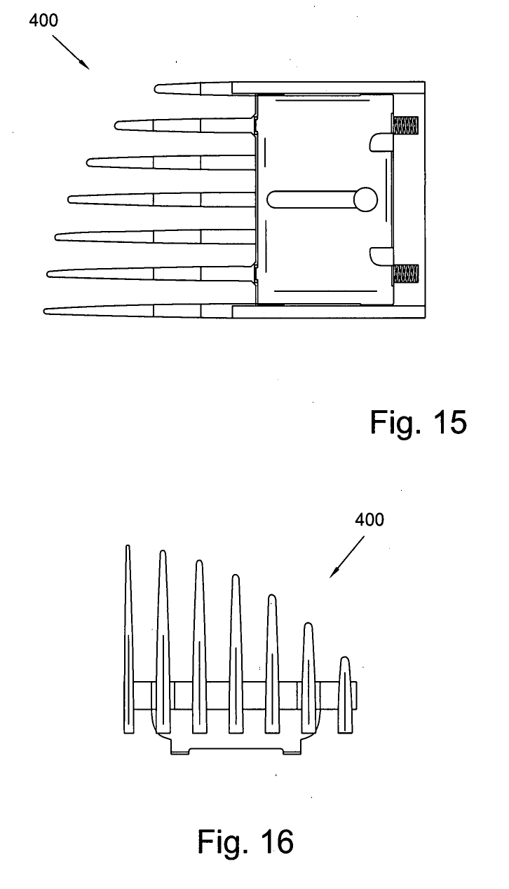

Alternatively, a greater amount of biasing or tapering to the hair relative to comb attachment 100 may be necessary. FIGS. 15 and 16 show left-side biased comb attachment 400 from the bottom and front, respectively. Comb attachment 400 will create a much higher gradient of biasing, contouring, or tapering of the hair. It should be appreciated, that right-side biased comb attachments relative to comb attachments 300 and 400 are within the scope of the invention. The comb attachments shown in FIGS. 13-16 illustrate examples of comb attachments that can be packaged together in a comprehensive set for creating various hair styles.

FIGS. 17-20 illustrate a method of cutting hair with a biased comb attachment. FIGS. 17-20 illustrate this method by using clipper assembly 10. This method of cutting hair with a biased comb attachment includes several steps. Firstly, as is shown in FIG. 17, the comb attachment is placed against surface 500 at first angle 502. Then, clipper assembly 10 is moved in a first direction along surface 500 for at least a portion of a length of surface 500. Contact is maintained between a first portion of a top-face surface of biased comb attachment 12 and surface 500 during this movement. Clipper assembly 10 is arranged to cut the hair in a second direction substantially perpendicular to the first direction. In FIG. 17 and the embodiment illustrated therein, the first direction is perpendicularly into the page. It should appreciated that the first direction can be in any direction suitable for the particular haircut.

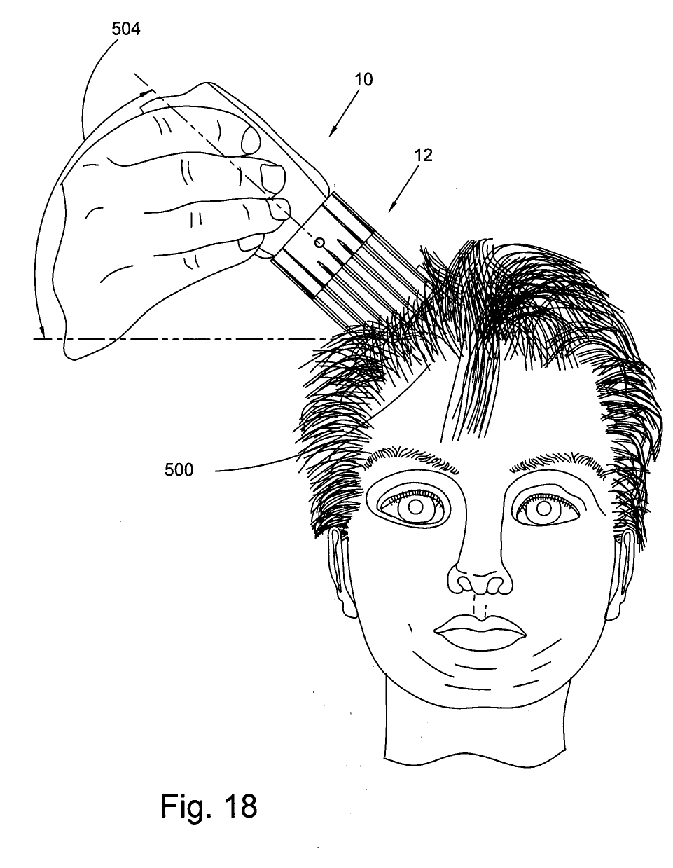

The next step is shown in FIG. 18. FIG. 18 illustrates clipper assembly 10 being rotated about a first axis wherein that first axis is parallel to the first direction of movement of clipper assembly 10. Specifically, clipper assembly is moved a second time across surface 500 at a second angle 504, engaging a second portion of a top-surface of comb attachment 12, and cutting the hair at a different angle relative the biased shape of comb attachment 12 than the initial cut at first angle 502. In a most preferred embodiment, this process is repeated about four to six times at four to six different angles, each time engaging a different portion of the top surface of comb attachment 12 surface 500. This is advantageous over the prior art, whereby to get an angled, tapered, biased, or contoured shape to the hair, a non-biased hair clipper assembly would have to be held away from surface 500 or at a specific point of contact, instead of a surface. The surface contact allows for a much more efficient cutting of hair by reducing the amount of time and skill required to maintain symmetry.

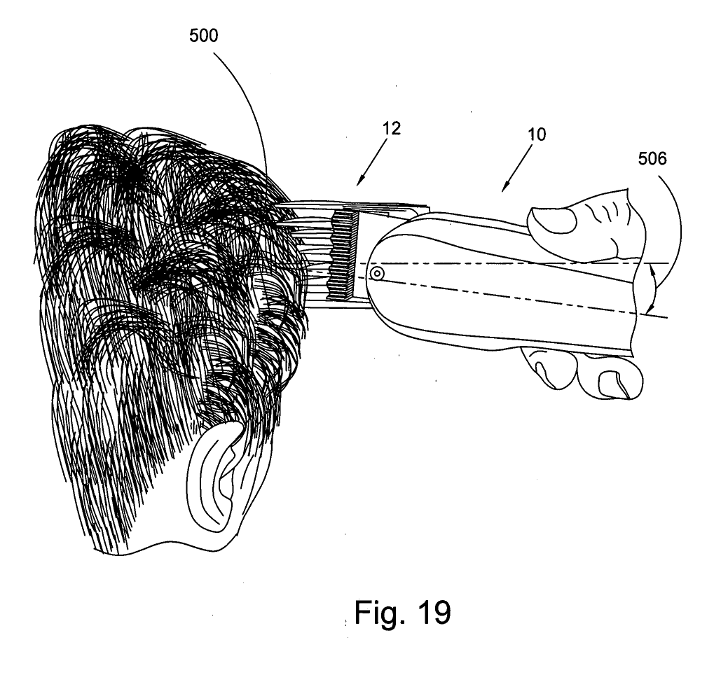

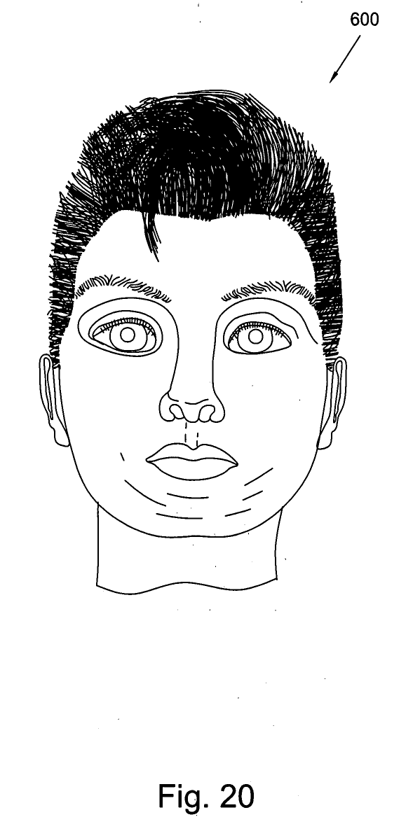

FIG. 19 illustrates a perspective view from the rear of clipper assembly 10 being moved in the first direction, cutting hair at third angle 506.

FIG. 20 illustrates a final product of utilizing the method and apparatus of the present invention, showing tapered, biased, or contoured hair style 600.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

I claim:

1. A comb attachment for a hair clipper, comprising:
a plurality of spaced apart parallel teeth extending substantially perpendicularly from a base of said comb attachment, wherein said plurality of teeth comprise a first tooth and a second tooth;
said first tooth having a first contoured shape;
said second tooth having a second contoured shape, wherein said first and second contoured shapes are different; and,
an attachment means for removably securing said comb attachment to said hair clipper.

2. The comb attachment according to claim 1, further comprising:
a third tooth having a third contoured shape, wherein said third contoured shape is different than said first and second contoured shapes; and,
a biased curved top surface formed by said first, second and third contoured shapes.

3. The comb attachment according to claim 2, wherein a cross-section of said biased curved top surface formed by said first, second and third contoured shapes is substantially parabolic in shape.

4. A plurality of comb attachments according to claim 2, each of said comb attachments comprising a unique biased curved top surface.

5. The comb attachment according to claim 1,
said first tooth comprising a first length and a first depth, and said second tooth comprising a second length and a second depth, and
said second length being longer than said first length and said second depth being larger than said first depth.

6. The comb attachment according to claim 5, further comprising:
a third tooth comprising a third contoured shape, a third length and a third depth, wherein said third contoured shape is different than said first and second contoured shapes and said third length being longer than said second length and said third depth being larger than said second depth; and,
a biased curved top surface formed by said first, second and third contoured shapes.

7. The comb attachment according to claim 6, wherein a cross-section of said biased curved top surface formed by said first, second and third contoured shapes is substantially parabolic in shape.

8. A comb attachment for a hair clipper, comprising:
a plurality of teeth extending in a substantially perpendicularly direction from a base of said comb attachment, each of said plurality of teeth comprising a curved top edge;
a top-face surface formed by a combination of said curved top edges, said top-face surface comprising a biased curve in a direction substantially perpendicular to said curved top edges; and,
an attachment means for removable securing said comb attachment to said hair clipper.

9. A plurality of comb attachments according to claim 8, each of said comb attachments comprising a unique top-face surface.

10. The comb attachment according to claim 8, wherein said biased curve is substantially parabolic in shape.

11. The comb attachment according to claim 8, wherein said biased curve is substantially hyperbolic in shape.

12. The comb attachment according to claim 8, wherein said biased curve has a non-linear slope.

13. The comb attachment according to claim 8, wherein said biased curve is a non-linear biased curve.

14. A method of cutting hair with an electric hair clipper comprising a biased comb attachment releaseably secured thereto, said method comprising the steps of:
a) moving said hair clipper in a first direction for at least a portion of a length of said surface, wherein contact is maintained between a top-face surface of said biased comb attachment and said surface and said hair clipper is arranged to cut said hair in a second direction substantially perpendicular to said first direction;
b) rotating said biased comb attachment along a first axis; and,
c) moving said hair clipper in said first direction for said at least a portion of a length of said surface, wherein contact is maintained between said top-face surface of said biased comb and said surface and said hair clipper is arranged to cut said hair in said second direction.

15. The method of cutting hair recited in claim 13, wherein said first axis is parallel to said first direction.

16. The method of cutting hair recited in claim 13, further comprising the steps of:
d) moving said hair clipper in a third direction for at least a second portion of a length of said surface, wherein contact is maintained between a top-face surface of said biased comb and said surface and said hair clipper is arranged to cut said hair in a fourth direction substantially perpendicular to said third direction;
e) rotating said biased comb attachment relative to said surface; and,
f) moving said hair clipper in said third direction for said at least a second portion of a length of said surface, wherein contact is maintained between said top-face surface of said biased comb attachment and said surface and said hair clipper is arranged to cut said hair in said fourth direction.
